(19) United States
(12) Patent Application Publication
(10) Pub. No.: US 2021/0179168 A1
(43) Pub. Date: Jun. 17, 2021

(54) METHOD FOR OPERATING A POWER STEERING SYSTEM OF A VEHICLE, POWER STEERING SYSTEM AND VEHICLE

(71) Applicant: ZF Automotive Germany GmbH, Alfdorf (DE)

(72) Inventor: Peter Zeiler, Düsseldorf (DE)

(73) Assignee: ZF Automotive Germany GmbH, Alfdorf (DE)

(21) Appl. No.: 17/123,207

(22) Filed: Dec. 16, 2020

(30) Foreign Application Priority Data
Dec. 16, 2019 (DE) 102019134568.5

(51) Int. Cl. B62D 6/00; B62D 15/02

(52) U.S. Cl. CPC B62D 6/008; B62D 15/0245; B62D 15/0215

(57) ABSTRACT

A method for operating a power steering system (12) of a vehicle (10) comprises the following steps:
a) preparation and/or calculation of a characteristic curve (a), which indicates a power assistance (F₁) to be applied by the power steering system (12) as a function of a driver manual torque (M),
b) determination of an initial steering angle s (x₁) of a steering wheel (24),
c) determination of a disturbing force, which acts on a steering train (22) of the vehicle (10) due to external forces,
d) compensation for the disturbing force by means of an applied compensating force (F₃) in such a way that a steering rack force (F₂) at the initial steering angle (x₁) assumes an initial value, in particular the initial value zero, and
e) application of a synthesized steering rack force (F₄) to produce a desired driving feel.

A power steering system and a vehicle comprising such a power steering system are furthermore described.

### RELATED APPLICATION

This application claims priority to German Patent Application No. 102019134568.5 filed Dec. 16, 2019, the disclosure of which is incorporated herein by reference in its entirety.

### BACKGROUND OF THE INVENTION

The invention relates to a method for operating a power steering system of a vehicle, a power steering system for performing the method and a vehicle having such a power steering system.

Modern steering devices in motor vehicles, for example electrical power steering (EPS), aid the driver in controlling the vehicle by applying power assistance to the steering train of the vehicle. In this way any disruptive steering rack forces occurring can be compensated for combining the driver manual torque applied by the driver with the power assistance generated by the EPS.

The steering rack force is substantially influenced by any lateral forces occurring, but also by the condition of the road surface and other factors dependent on the current driving situation.

In addition, further contributory factors that affect the handling of the vehicle arise due to the increasing prevalence of driver assistance systems, which can also intervene autonomously in the steering behavior of the vehicle.

Balancing these parameters influences the driving “feel” experienced by the driver and presents a complex challenge in designing the vehicle, particularly with regard to the competing steering rack forces applied by the driver and the driver assistance system.

### SUMMARY OF THE INVENTION

The object of the invention is to provide a facility giving the driver a desired and expected driving feel in a variety of driving situations.

According to the invention the object is achieved by a method for operating a power steering system of a vehicle, comprising the following steps:

a) determination of an initial steering angle of the steering wheel,

b) determination of a disturbing force acting on a steering train of the vehicle due to external forces,

c) compensation for the disturbing force by means of an applied compensating force in such a way that a steering rack force at the initial steering angle assumes an initial value, in particular the initial value zero, and

d) application of a synthesized steering rack force (F₄) to produce a desired driving feel.

The compensating force serves to correct the steering rack force occurring, which is caused in particular by the external forces acting on the steering train, so that the steering rack force assumes the initial value, at least at the initial steering angle.

By then applying an additional synthesized steering rack force, the driving feel to be expected in the neutral position of the steering wheel can be transmitted to any initial steering angle.

This allows adjustment of the steering feel at different steering angles without having to undertake any adjustment of the mechanical components of the vehicle. In this way the tuning outlay in order to coordinate the components of the vehicle with one another is considerably reduced.

In particular, the magnitude of the applied synthesized steering rack force varies around the initial steering angle and is selected in such a way as to produce a desired steering resistance characteristic.

The desired steering resistance characteristic corresponds in particular to the disturbing force characteristic to be expected around a neutral steering angle, the neutral steering angle corresponding to the neutral position of the steering wheel.

The method according to the invention may additionally comprise the following steps: first a characteristic curve is prepared and/or calculated, which indicates a power assistance to be applied by the power steering system as a function of a driver manual torque. The driver manual torque applied is then measured. Next, on the basis of the driver manual torque applied, the power assistance is determined by means of the characteristic curve and the power assistance is applied to the steering train of the vehicle.

The characteristic curve prepared and/or calculated corresponds in particular to the power assistance of a servomotor, hereinafter also referred to as the servo assistance, to be expected of a normal EPS in the event of steering angle variations around the neutral position of the steering wheel. As a rule, the driver is accustomed to such a characteristic curve and expects a corresponding assistance.

The characteristic curve can be prepared and/or calculated on the basis of the current driving maneuver, in particular on the basis of the speed of the vehicle. In this way it is possible to achieve a specific steering rack force as a function of the driving maneuver. The speed of the vehicle here represents one of the greatest factors influencing the steering rack force.

The driver manual torque applied may also be zero, for example during straight-line driving of the vehicle.

The total force applied by the power steering system is the sum of at least the compensating force, as determined in step c), the synthesized steering rack force, as applied in step d), and optionally the power assistance, which is determined by means of the characteristic curve on the basis of the driver manual torque.

In order to compensate fully for the influence of all specific disturbing forces, the disturbing force may be compensated for in such a way that the sum of the disturbing force and the compensating force assumes the initial value for all steering angles.

In one variant the power assistance, the compensating force and/or the synthesized steering rack force are exerted on the steering rack by means of an actuator, for example by means of an electric motor. For this purpose, a single actuator may be used for applying both the power assistance, the compensating force and also the synthesized steering rack force. Alternatively, a separate actuator may be available for applying the power assistance, the compensating force and/or the synthesized steering rack force.

The power assistance, the compensating force and/or the synthesized steering rack force may also be applied through the application of a torque in the steering column.

The disturbing force may result, at least in part, from interference to the lateral control of the vehicle. For example, the disturbing force may be caused by a steep road surface, cross winds and/or uneven weight distributions of the vehicle.

In principle it is also possible to only use selected disturbances in determining the compensating force.

In a further variant the compensating force is selected so that at least elements of the disturbing force are at least partially and in particular fully compensated for and/or elements of the disturbing force are amplified.

The corresponding proportional fractions of the disturbing force may therefore be compensated for and/or especially emphasized depending on the desired driving feel.

The disturbing force may be determined by means of a disturbance variable monitor and/or a reference value. The disturbance variable monitor in particular comprises a sensor, which is fitted, for example, directly to the axle of the vehicle. The disturbance variable monitor generally regulates the steering rack moment as the controlled variable.

The reference value may be determined on the basis of the vehicle model, on the basis of a characteristics map of the vehicle and/or as a function of the speed.

In one variant the vehicle comprises a steering angle control module, which sets the initial steering angle. The steering angle control module may be part of a driver assistance system, for example a lane-keeping assist system or an autonomous or semi-autonomous driving assistance system.

The steering angle control module may calculate an assistance force, which is likewise applied to the steering train of the vehicle and which corresponds to a steering lock from the neutral position to the initial steering angle.

The steering angle control module therefore does not distort the prepared and/or calculated power assistance characteristic curve.

If a steering angle control module is used, the method according to the invention is particularly advantageous, since the initial steering angle will ordinarily not correspond to the neutral position of the steering wheel. Nevertheless, in the event of intervention by the driver the method according to the invention can serve to give the driver the steering feel that he would expect in the neutral position of the steering wheel or around the neutral position.

The steering angle control module may exert the assistance force on the steering train by means of an actuator. In particular, the steering angle control module exerts the assistance force by means of the same actuator that is also used to apply the power assistance, the compensating force and/or the synthesized steering rack force.

The steering angle control module in particular comprises a closed-loop with no integral component. Accordingly, in the event of a driver intervention, which represents a control interference variable for the steering angle control module, no automatic adjustment of the steering angle will be undertaken. In this way, unwanted fluctuations are avoided in the event of an intervention by the driver.

The object of the invention is furthermore achieved by a power steering system having a control module, a steering angle sensor and an actuator for generating a power assistance, a compensating force and/or a synthesized steering rack force, the power steering system being designed to perform the method of the type previously described.

The control module may comprise a driver manual torque module for determining the driver manual torque applied and/or a power assistance module for determining the power assistance, the compensating force and/or the synthesized steering rack force.

The power steering system furthermore in particular comprises a steering angle control module.

Furthermore, according to the invention the object is achieved by a vehicle comprising such a power steering system.

### BRIEF DESCRIPTION OF THE DRAWINGS

Further features and characteristics of the invention emerge from the following description and from the drawings, in which:

FIG. 1 shows a motor vehicle according to the invention having a power steering system according to the invention,

FIG. 2 shows diagram of the power assistance generated by an EPS as a function of the driver manual torque,

FIG. 3 shows a diagram of the steering rack force characteristic as a function of the steering angle,

FIG. 4 shows a flow chart of the method according to the invention,

FIG. 5 shows a block diagram of the contributors to the force applied by the power steering system in FIG. 1, and

FIG. 6 shows a block diagram of the control structure of the power steering system in FIG. 1.

### DESCRIPTION

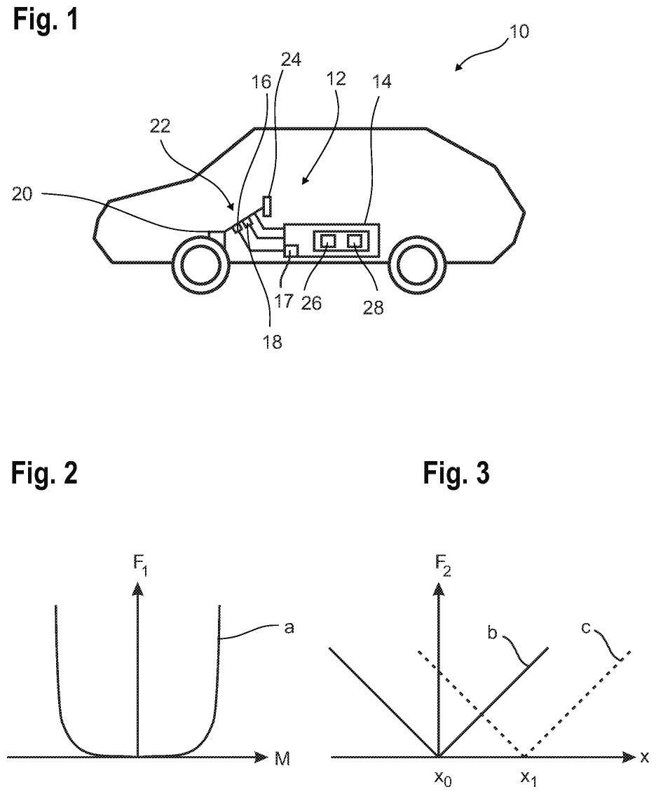

FIG. 1 schematically shows a vehicle 10 according to the invention having a power steering system 12 according to the invention.

The power steering system 12 comprises a control module 14, a steering angle sensor 16, a steering angle control module 17 and an actuator 18 for generating a force F.

The vehicle 10 comprises a steering rack 20, which is connected to a steering train 22. The steering train 22 can be operated by a driver (not shown) via a steering wheel 24.

The steering angle sensor 16 monitors the position of the steering wheel 24 and is therefore able to determine a steering angle x of the steering wheel 24.

The actuator 18 is, for example, an electric motor and can therefore act on the steering train 22, in order to steer the vehicle 10. To put it another way, the actuator 18, by means of the force F applied, is able to produce a movement, in particular a rotational movement, of the steering train 22.

The control module 14 further comprises a driver manual torque module 26 which can be used to determine the driver manual torque M applied by the driver to the steering wheel 24.

The control module 14 further comprises a power assistance module 28 that serves to determine a power assistance F₁ which in a steering movement is applied to the steering train 22 by means of the actuator 18.

In basic operation of the vehicle 10 the power steering system 12 provides a power assistance F₁, which varies as a function of the driver manual torque M according to the characteristic curve a represented in FIG. 2. The power assistance F₁ is in this case equal to the total force F applied by the power assistance system 12.

Conventional EPS-systems provide the driver with power assistance F₁ that increases symmetrically around a zero point, an ever more rapid increase in the power assistance F₁ being observable with increasing driver manual torque M, as shown in FIG. 2.

The zero point of the characteristic curve a usually coincides with a neutral position of the steering wheel 24. The driver of the vehicle 10 therefore receives the same power assistance F₁ for the same driver manual torque M irrespective of the steering direction

In FIG. 3 the steering rack force F₂ of the steering rack 20 is represented as a function of the steering angle x of the steering wheel 24. It can be seen that in the neutral position of the steering wheel 24, which corresponds to a neutral steering angle x₀, the steering rack force F₂ is minimal and increases symmetrically around the steering angle x₀ as a function of the steering angle x, as is illustrated by the characteristic line b.

The characteristic line b accordingly describes the characteristic of the steering rack force F₂ around the neutral steering angle x₀, which is a measure of the steering resistance around the neutral steering angle x₀.

The driving feel experienced by the driver of the vehicle 10 results from the interplay between the driver manual torque M applied, and hence also the power assistance F₁, and the steering rack force F₂.

The method according to the invention for operating the power steering system 12 of the vehicle 10 serves to transfer this driving feel to any steering angle x, for example to the initial steering angle x₁ represented in FIG. 3.

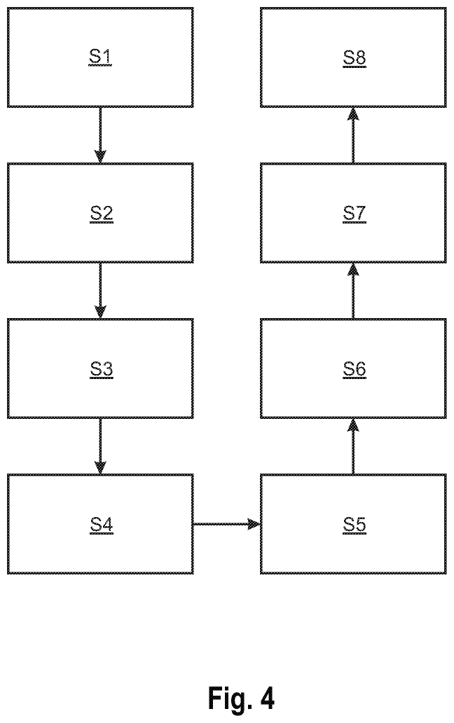

FIG. 4 shows a flow chart of the method according to the invention, which is explained in more detail below.

In a first mode of the power steering system 12 it is to be operated so that the driving feel experience by the driver is independent of disturbing forces acting on the vehicle 10.

For this purpose, an initial steering angle x₁ of the steering wheel 24 is first determined and an initial value is defined for the steering rack force F₂ which the driver is intended to experience at the initial steering angle x₁ (step S1). The initial steering angle x₁ is, for example, the current steering angle and is determined, for example, by means of the steering angle sensor 16.

A disturbing force which acts on the steering train 22 of the vehicle 10 due to external forces is then determined (step S2). The disturbing force results, at least in part, from interference to the lateral control of the vehicle 10, for example by steep road surfaces, cross winds and/or uneven weight distributions of the vehicle 10. The characteristic of the steering rack force F₂ is substantially predetermined by the disturbing force.

A disturbance variable monitor 29 (cf. FIG. 6) and/or a reference value may be used for determining the disturbing force. The reference value may likewise be vehicle-based and/or vary as a function of the speed.

Now a compensating force F₃ is determined, which is intended to offset the disturbing force to the initial value. To put it another way, the compensating force is selected so that the sum of the disturbing force and the compensating force produces the initial value, in particular for all steering angles.

The compensating force is then applied, and the calculated disturbing force is thus at least partially and in particular fully compensated for (step S3). Here the steering rack force F₂, at least at the initial steering angle x₁, but in particular for all steering angles, assumes a fixed initial value, which in the embodiment shown is equal to zero.

In principle, however, any other desired initial value could also be selected. This is of particular interest if specific contributions to the disturbance variable are even to be amplified, for example in order to provide the driver of the vehicle 10 with information on the road surface condition.

In addition, a synthesized steering rack force F₄ is applied to the steering train 22 of the vehicle 10, for example by the actuator 18 (step S4), so as to produce a desired characteristic of the steering rack force F₂ corresponding to the curve c around the initial steering angle x₁ (cf. FIG. 3). The characteristic of the curve c around the initial steering angle x₁ here corresponds to the expected characteristic of the curve b around the neutral steering angle x₀, as had resulted in step S2 before applying the compensating force F₃—that is to say the expected characteristic of the disturbing force. A desired steering resistance characteristic around the initial steering angle x₁ is therefore generated via the synthesized steering rack force F₄.

It is also feasible for the desired characteristic produced by the synthesized steering rack force F₄ to deviate from the expected characteristic of the disturbing force, in order to tailor the driving feel and/or the steering resistance.

Here the desired characteristic may always be based on the characteristic of the disturbing force, since the driver expects a steering resistance or a driving feel that does not deviate too much from the disturbing force.

The magnitude of the synthesized steering rack force F₄ may alternatively or additionally be selected on the basis of driving parameters, such as the vehicle speed, the lateral acceleration etc.

The magnitude of the compensating force F₃ and/or the synthesized steering rack force F₄ to be applied may likewise be determined by the power assistance module 28. Alternatively, a separate module could be provided for determining the compensating force F₃ and/or the synthesized steering rack force F₄.

The power assistance F₁ to be applied by the power steering system 12 may optionally be calculated as a function of the driver manual torque M. For this purpose, a characteristic curve, for example the characteristic curve a in FIG. 2, is first prepared and/or calculated (step S5).

The characteristic curve may be prepared and/or calculated, for example, as a function of the vehicle model, the current driving maneuver and/or the current speed of the vehicle 10.

The use of a characteristic curve as in FIG. 2, i.e. a characteristic curve of a conventional EPS, presents itself, since drivers of modern vehicles nowadays expect a power assistance which conforms to this characteristic curve.

Then, the driver manual torque M applied is additionally measured, in order to determine the steering intention of the driver (step S6). This is done, for example, by the driver manual torque module 26 of the control module 14.

The driver manual torque M determined is used as a basis for determining, via the characteristic curve a and after compensation for all disturbing variables and application of the synthesized steering rack force, the power assistance F₁ needed in order to give the driver the same driving feel around the initial steering angle x₁ as he would expect around the neutral position of the steering wheel 24 in the previously explained basic operation of the power steering system 12 (step S7).

Finally, the power assistance F₁ determined is applied to the steering train 22 of the vehicle 10, for example via the actuator 18 (step S8).

The driver in his steering movement is therefore supported by the power assistance F₁ in precisely the way he would expect, that is to say on the basis of the characteristic curve a in FIG. 2. This represents a considerable difference compared to the prior art, in which no compensating force F₃ and no synthesized steering rack force F₄ is applied. In the prior art the driver must himself apply a corresponding steering torque to compensate for the disturbing force, in order to maintain his course. If he now performs a steering movement to change course, the power assistance F₁ would not be calculated from the origin of the characteristic curve a, however, but from the steering torque already applied. This leads to an asymmetrical power assistance F₁, which the driver is not used to and/or does not expect.

The initial steering angle x₁, particularly in this first mode of the power steering system 12, may also correspond to the steering angle x₀. In this case the method according to the invention serves primarily to compensate for the disturbing forces acting on the vehicle 10, since the contribution of the synthesized steering rack force F₄ in this case may be zero.

However, with the aid of the steering angle control module 17 the power steering system 12 according to the invention can also be operated in a second mode.

In the second mode the steering angle control module 17 sets the initial steering angle x₁. For example, the steering angle control module 17 is designed as a driver assistance system, in particular as a lane-keeping assist system and/or an autonomous or semi-autonomous driving assistance system.

Accordingly, in this case the driver of the vehicle 10 may happen to intervene in a steering wheel 24 deflected from the neutral position. In this case the driver, immediately on grasping the steering wheel 24, will obtain the driving feel which he would expect in the neutral position of the steering wheel 24.

For this purpose, the steering angle control module 17 calculates an assistance force F₅, which corresponds to a steering lock from the neutral position to the initial steering angle x₁. This force is applied to the steering train 22 of the vehicle even prior to step S1 or in step S8 in addition to the power assistance F₁.

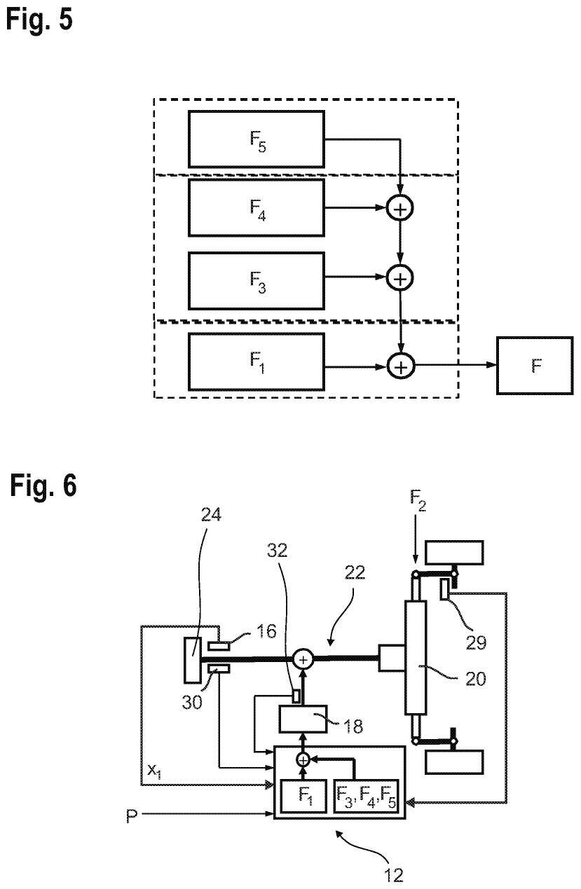

The different proportions of the total force F applied to the steering train 22 applied are illustrated schematically in FIG. 5, in which the contributions in basic operation, in the first mode and in the second mode are listed from bottom to top.

FIG. 6 schematically represents the interaction of the various components of the vehicle 10 and the power steering system 12.

The steering train 22 is connected to the steering rack 20.

Steering rack forces F2 act on the steering rack 20. In addition, disturbing forces act on the steering rack 20 and the steering train 22, in particular disturbing forces acting on the lateral control of the vehicle 10, that is, for example, in the same direction as the steering rack force F₂ indicated by an arrow in FIG. 6.

Fitted to the steering train 22 is the steering wheel 24, the steering angle x of which can be determined by a steering angle sensor 16. The currently prevailing steering angle x is transmitted as initial steering angle x₁ to the power steering system 12.

In addition, the driver manual torque M applied to the steering wheel 24 is determined by means of a driver manual torque sensor 30 and likewise relayed to the power steering system 12.

In addition, further parameters P to be taken into account can be transmitted to the power steering system 12, for example the current speed of the vehicle 10.

The power steering system 12, in accordance with the method described above, calculates a force F which may comprise both the power assistance F₁ and also—depending on the mode in which the power steering system 12 is being operated—contributions by the compensating force F₃, the synthesized steering rack force F₄ and the assistance force F₅.

The actuator 18 may apply the force F to the steering train 22.

In the embodiment shown in FIG. 6 an additional second steering angle sensor 32 is provided, which serves to monitor the steering angle x after application of the force F by the actuator 18.

1. A method for operating a power steering system (12) of a vehicle (10), comprising the following steps:
determination of an initial steering angle s (x₁) of a steering wheel (24),
determination a disturbing force acting on a steering train (22) of the vehicle (10) due to external forces,
compensation for the disturbing force by means of an applied compensating force (F₃) in such a way that a steering rack force (F₂) at the initial steering angle (x₁) assumes an initial value, in particular the initial value zero, and
application a synthesized steering rack force (F₄) to produce a desired driving feel.

2. The method as claimed in claim 1, wherein the magnitude of the applied synthesized steering rack force (F₄) varies around the initial steering angle (x₁) and is selected in such a way as to produce a desired steering resistance characteristic, in particular wherein the desired characteristic of the synthesized steering rack force (F₄) corresponds to the disturbing force characteristic to be expected around a neutral steering angle (x₀), wherein the neutral steering angle (x₀) corresponds to the neutral position of the steering wheel (24).

3. The method as claimed in claim 1, wherein the method additionally comprises the following steps:
preparation and/or calculation of a characteristic curve (a), which indicates a power assistance (F₁) to be applied by the power steering system (12) as a function of a driver manual torque (M),
measurement of the driver manual torque (M) applied,
determination of the power assistance (F₁) by means of the characteristic curve (a) on the basis of the driver manual torque (M) applied, and
application of the power assistance (F₁) to the steering train (22) of the vehicle (10).

4. The method as claimed in claim 1, wherein the disturbing force is compensated for in such a way that the sum of the disturbing force and the compensating force (F₃) assumes the initial value for all steering angles (x).

5. The method as claimed in claim 1, wherein the characteristic curve (a) is prepared and/or calculated on the basis of the current driving maneuver, in particular on the basis of the speed of the vehicle (10).

6. The method as claimed in claim 1, wherein the power assistance (F₁), the compensating force (F₃) and/or the synthesized steering rack force (F₄) is exerted on the steering rack (20) by means of an actuator (18).

7. The method as claimed in claim 1, wherein the disturbing force results, at least in part, from interference to the lateral control of the vehicle (10).

8. The method as claimed in claim 1, wherein the compensating force (F₃) is selected so that at least elements of the disturbing force are at least partially and in particular fully compensated for and/or elements of the disturbing force elements are amplified.

9. The method as claimed in claim 1, wherein the disturbing force is determined by means of a disturbance variable monitor, which in particular comprises sensor, and/or by means of a reference value.

10. The method as claimed in claim 1, wherein the vehicle (10) comprises a steering angle control module (17), which sets the initial steering angle (x₁).

11. The method as claimed in claim 10, wherein the steering angle control module (17) determines an assistance force (F₅), which is likewise applied to the steering train (22) of the vehicle (10) and which corresponds to a steering lock from the neutral position to the initial steering angle (x₁).

12. The method as claimed in claim 9, wherein the steering angle control module (17) is capable of exerting the assistance force (F₅) on the steering train (22) by means of an actuator (18), in particular wherein the assistance force (F₅) and the power assistance (F₁) are exerted by the same actuator.

13. The method as claimed claim 10, wherein the steering angle control module (17) comprises a closed-loop with no integral component.

14. A power steering system having a control module (14), a steering angle sensor (16) and an actuator (18) for generating a power assistance (F₁), a compensating force (F₃) and/or a synthesized steering rack force (F₄), wherein the power steering system (12) is designed to perform the method as claimed in claim 1.

15. The power steering system as claimed in claim 13, wherein the control module (14) comprises a driver manual torque module (26) for determining the driver manual torque (M) applied and/or a power assistance module (28) for determining the power assistance (F₁), the compensating force (F₃) and/or the synthesized steering rack force (F₄).

16. The power steering system as claimed in claim 14, wherein the power steering system (12) comprises a steering angle control module (17).

17. A vehicle comprising a power steering system (12) as claimed in claim 14.
